(19) United States
(12) Patent Application Publication
(10) Pub. No.: US 2025/0381432 A1
(43) Pub. Date: Dec. 18, 2025

(54) Remote temperature sensor for fire suppression

(71) Applicant: Stephen Knight, Oklahoma City, OK (US)

(72) Inventor: Stephen Knight, Oklahoma City, OK (US)

(21) Appl. No.: 18/831,077

(22) Filed: Jun. 12, 2024

(51) Int. Cl. A62C 37/44; A62C 35/02

(52) U.S. Cl. CPC A62C 37/44; A62C 35/023

(57) ABSTRACT

A fire suppression system is installed and operated on a vehicle, trailer, machine or implement having wheels, bearings, gears or belt operated pulleys using temperature sensors in wireless communication with a central monitoring system to sense an elevated heat event or fire and activate one or more local, zonal or entire unit fire suppression foaming modules to dispense a fire suppression foam to one or more locations on the vehicle, trailer, machine or implement to avoid and suppress the fire or elevated heat event and alert an operator of the vehicle, trailer, machine or implement as to the real time occurrence of the elevated heat or fire event in time to take remedial action to minimize or avoid damage to person or property, including livestock and cargo.

### CROSS REFERENCE TO RELATED APPLICATIONS

This is a Continuation-in-Part application of U.S. patent application Ser. No. 18/445,551 Filed by the same Inventor on Oct. 10, 2023.

### BACKGROUND OF THE INVENTION

### 1. Field of Invention

A plurality remote temperature sensor incorporated into a fire suppression system for vehicles, trailers and equipment operating on a wireless signal to provide for an adjustable temperature sensing of a component part of the vehicle, trailer or equipment and transmitting an alert signal in communication with a processing unit and further initiating a fire suppression system in a zone or over the entire vehicle, trailer or equipment to prevent or to extinguish a fire or to mitigate rising heat of a component automatically once the system is calibrated and the processing unit is programmed and established in operation. A sensor display is also part of the unit to observe operation and activity of the fire suppression system and remote temperature sensors

### 2. Description of Prior Art

A preliminary review of prior art patents was conducted by the applicant which reveal prior art patents in a similar field or having similar use. However, the prior art inventions do not disclose the same or similar elements as the present remote temperature sensor for a vehicle fire suppression system, nor do they present the material components in a manner contemplated or anticipated in the prior art.

A preliminary review of prior art patents was conducted by the applicant which reveal prior art patents in a similar field or having similar use. However, the prior art inventions do not disclose the same or similar elements as the present internal tank battery fire extinguisher module, nor do they present the material components in a manner contemplated or anticipated in the prior art. None of them attach to the inside of a tank battery containing combustible liquids and vapor. None of them are self-activating, sensing a sudden rise in temperature and activating at a set temperature threshold. None of them have the ability to adhere or attach to the inner wall and none of them evacuate a safe nitrogen foaming agent which floats on the surface of the liquid to suffocate the flammable vapors, saving both the tank batteries and the contents therein. They also are not adapted to transport trailers carrying flammable substrates or livestock.

A rim rolling fire suppression module is attached to the rim of a tank and is moved around the perimeter of the tank, detects the presence and location of the fire and then moves the module to the location to expel suppression agents onto the heat source in U.S. Pat. No. 4,781,252 to Wilburn. In U.S. Pat. No. 8,955,609 to Phillips, an external vessel delivers a suppression agent through tubing and distributors to the contents of a tank after a glass, plexi-glass or plastic case is broken or melted, activating a release of the contents of the external tank into the tubing and further to one or more dispersion heads by suffocating the fire with an aqueous film forming material. In the Enk, Sr. U.S. Pat. No. 9,381,388, two separate tanks dispensing a liquid mixture released to form a semi-rigid closed cell foam within a tank, the suppression system having a detector and a pressurized propellant leading to dispersion nozzles that direct the mixture onto the surface of the contents of the tank. This patent was also published as U.S. Patent Application Publication No. 2016/0263410.

In Patent Publication No. 2019/0168047 to Conboy, suppresses fires in a building, vessel or vehicle using a cloud of microscopic droplets generated from a supply of environmentally clean water and a water based free-radical chemical reacting together to cool the fire and displace oxygen. An industrial vehicle fire suppression system installs into a truck containing heavy goods with two hose reels delivering a suppression liquid comprising a toroidal-shaped tank having a water and foaming agent and a delimiting department, a pressurizing box containing a pressurization means and a mixing chamber combining nitrogen/air and the suppression water and chemical mixture to the two hose reels further applying the water, chemical nitrogen/air mixture through the hoses to extinguish a fire in the vehicle, as disclosed in U.S. Patent Publication no 2019/0224507 to Fiorino.

Specifically relating to temperature sensors, a variety of patents and application have described several versions of devices that determine temperatures of various locations or objects and provide either a local or remote indication of that temperature on another device, and in some cases triggers the operation of something that addresses the sensed heat. A process for the operation of a thermally regulating sensor is addressed in U.S. Pat. No. 10,429,409 to Pan to set a relationship between a heat sensor's bias and the heat sensor temperature. An infrared pyroelectric sensor having optical windows for sensing heat in a 360 degree area uses a thermopile sensor located within a sealed chamber with two smoke detectors through ventilation holes communicating with the chamber, the shell housing at least one printed circuit board coupled to the sensors and detectors and supporting a computer and radio transmitter and a rechargeable power source is disclosed in U.S. Pat. No. 8,907,799 too McKenna. Thermal sensors for measuring the heat in a fracking pump and send a remote signal to a processing system is described in U.S. Patent Publication NO. 2021/0306720 to Sandoval.

The most closely related prior art is found in U.S. Pat. No. 10,739,204 to Duryea, which conducts in process and system on wheel bearings which have a remote temperature sensor built within adjacent non-rotating sections of axle assemblies on multiple axle vehicles and trailers. These imbedded sensors in FIG. 4 of Duryea are located within the spindle and utilize a wireless signal (Bluetooth®, wireless fidelity/Wi-FI using IEEE802.11 standards, or other dedicated low power radio signal) to communicate with a smart phone or tablet which provides a display of the multiple wheel bearings registering a constant temperature reading of each wheel bearing and shown in Duryea's FIG. 3. It provides an alert response but does not activate any remedial suppression of the elevated temperature, merely letting an operator know it is time to pull over to inspect the suspect wheel bearing.

### SUMMARY OF THE INVENTION

A remote temperature sensor and fire suppression system is provided to be installed on a mobile trailer or implement to monitor a fire or overheated element to alert an operator of an actual or potential threat of fire during operation and an immediate suppression of the fire or potential fire using a liquid foaming fire suppression agent directed in a zone or immediate vicinity of the fire or potential fire source. It is know that trailers carrying livestock or other loads can have fires erupt during travel caused by either bearing friction, road hazards, tossed cigarettes, locked brakes, damaged tires or belt friction, among several reported ignition incidents. Most often, without any forewarning or immediate notification of such ignition incident, drivers of the trailers and implements are unaware that the ignition is occurring and may inadvertently allow the fire to have become out of control. Early warning could have avoided the out of control episode and given the operator time to extinguish the fire or clear the trailer of a load of livestock, combustion source or load prior to catastrophic loss. This also occurs during use of implements and machinery that has bearings, belts or other operational components that can generate combustion heat when broken, impaired, impacted with debris or combustible materials or simply worn beyond useful function.

The current temperature sensor and fire suppression system allows the operator or driver using the trailer or implement to be alerted in real time and to have a system which instantaneously determines the source of the potential or actual fire, the location of the potential or actual fire, and automatically directs a flow of fire suppression chemical to the source or zone of the potential or actual fire and contemporaneously alerts the operator of the real time potential or actual fire event in order to safely pull off the roadway or stop the implement usage until such time as the fire has been suppressed and mitigation of damages is allowed to occur.

### DESCRIPTION OF THE DRAWINGS

The following drawings are submitted with this utility patent application.

FIG. 1 is a diagram of a remote wireless temperature sensor used in a vehicle or implement fire suppression system

FIG. 2 is a diagram of a wireless communication system between the components of the wireless temperature sensor, the fire sensor module, the wireless transmitter module, the fire suppression system and the wireless display module.

FIG. 3 is a chart showing the functional flow process of the fire detection and the fire suppression system during a fire or excessive heat event and the automatic activation of one or more fire suppression areas in the vehicle or implement.

FIG. 4 is a top view of a livestock trailer having a plurality of temperature remote sensors, a plurality of fire suppression plural tank modules and an identity of various fire suppression zones.

FIG. 5 is a side sectional view of the same livestock trailer having a plurality of temperature remote sensors, a plurality of relative fire suppression singular tank modules and an identity of various fire suppression zones.

FIG. 6 is a top view of the same livestock trailer having a plurality of temperature remote sensors, a plurality of relative fire suppression plural tank modules with extended nozzle arrays and an identity of various fire suppression zones.

FIG. 7 is a bottom view of the livestock trailer having below deck remote temperature sensors with dedicated sensors directed at the wheel bearings and brakes, and dual tank suppression modules with extended nozzle arrays directed at the wheel bearings.

FIG. 8 is a round bale agricultural implement with one or more fire suppression singular tank modules with extended dispersal spray nozzles directed to bearing locations on the implement being monitored with remote temperature sensors having the temperature probe directed in proximity to each bearing.

FIG. 9 is a diagram of an embodiment of a remote activated fire suppression tank, a remote activated check valve and a direction spray hose with a dispersal spray nozzle.

### DESCRIPTION OF THE PREFERRED EMBODIMENT

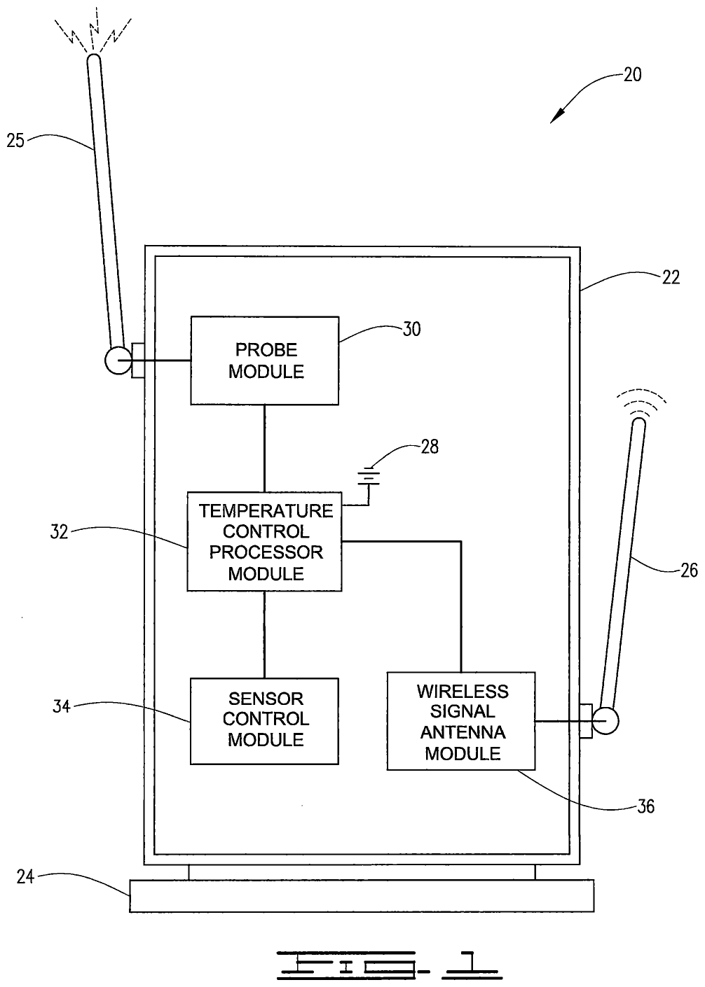

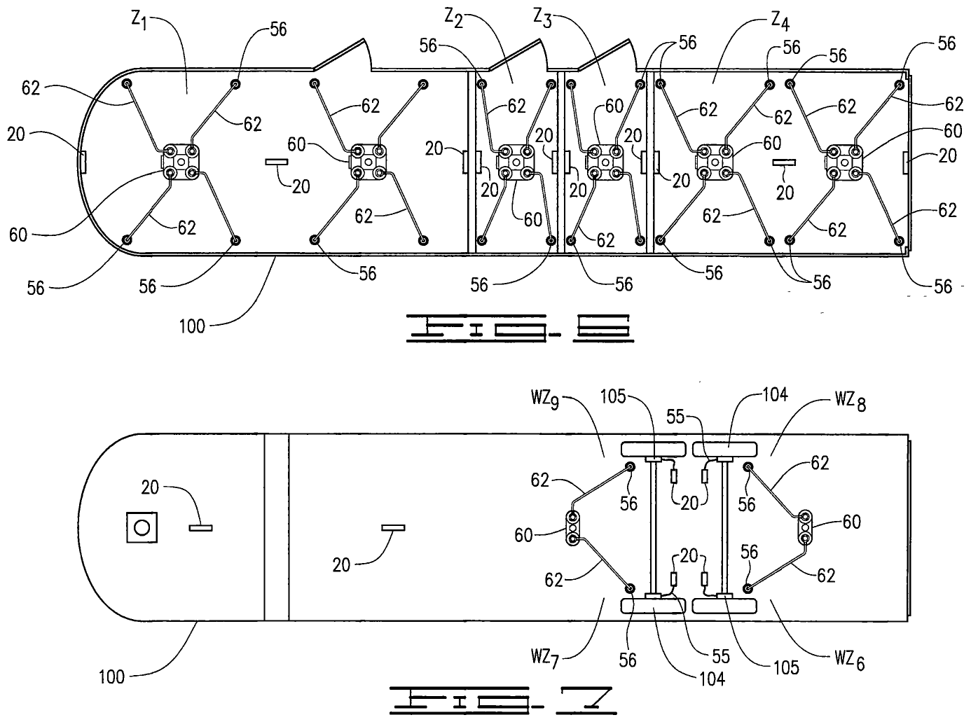

A fire suppression system 10 using one or more remote temperature sensors 20 in wireless communication with a central wireless transmitter module 80, display module 40, remote fire suppression equipment 50 including at least one tank 52, dispersal spray nozzles 56 directed to local, zonal or entire remote fire suppression equipment 50 installed in a trailer 100, machine or implement 200 to detect and remediate a fire or extreme heat source during an emergency event. The fire suppression system 10 comprises at least one set of remote fire suppression equipment 50 including tank 52 or tank bundles 60 containing a fire suppression liquid or foam, at least one respective dispersal spray nozzle 56 to direct the contents of the at least one fire suppression tank 52 or tank bundle 60 to a predetermined location which may be a singular location, a zone Zₓ or over the entire trailer 100 or implement 200 to which it installed, at least one temperature sensor 20 located at one or more point on the trailer, machine or implement involving a potentially anticipated heat or fire source as determined by experts in the field of fire suppression, a wireless communication comprising a central wireless transmitter module 80 system communicating a wireless signal to a remote fire suppression module 70 to activate selected sets of remote fire suppression equipment 50. The at least one remote temperature sensor 20 and the visual display module alert a person operating the trailer 100, machinery or implement 200 as to a real time fire event and real time status of the fire suppression system 10, as shown in FIGS. 1-9.

The need for this fire suppression system 10 arises from a driver of a trailer 100 or operator of machinery and implement 200 is often unaware of a fire event or a heat event until long after it has established its origin and gain and the fire or heat event has gotten to a point where it is out of control and serious and irreparable damage has already occurred. Events have been documented where livestock being transport has sustained permanent damage or death due to fire and smoke. Hay in a baler has become stuck in the entry or within the baler, caught fire and completely destroyed the implement and set the field on fire. In machinery, the operator has allowed a bearing or belt to heat to such extent that costly repair to the machine has developed which, if found sooner, could have been mitigated to a simple part replacement. Thus, this is an economic investment that could prevent a catastrophic loss to the operator or owner of the equipment to which it applied and can be replaced after having performed its task of fire suppression or prevention.

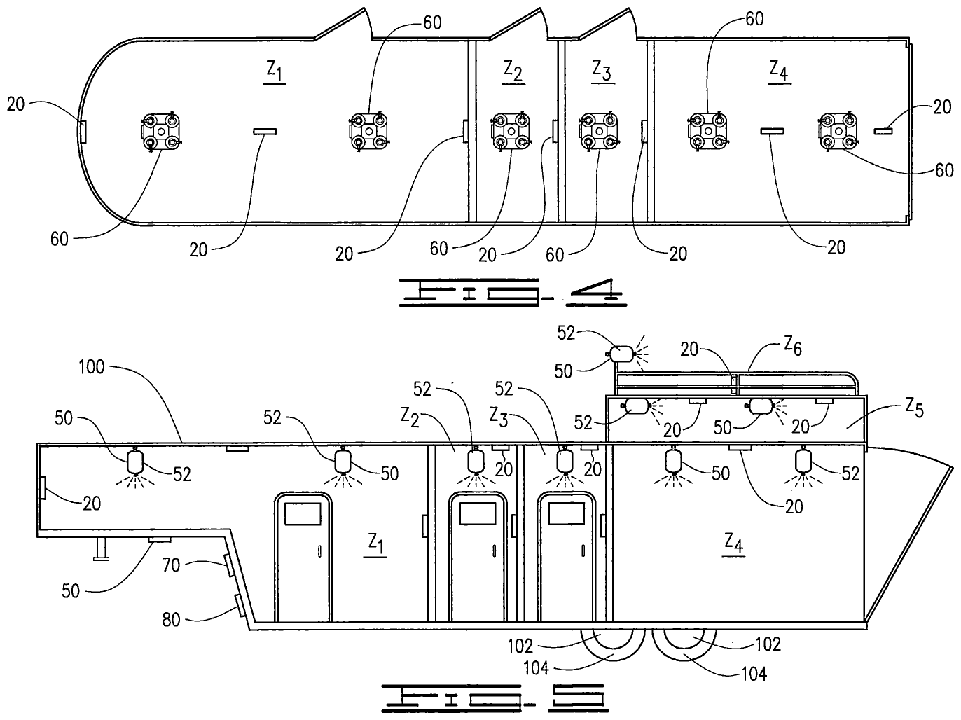

In a first embodiment adapted to the fire suppression system 10 for use in a towed trailer 100, the fire suppression system 10 defines one or more sets of wirelessly activated fire suppression equipment 50 installed in one or more areas or “zones” of the trailer 100 interior and exterior, individually, zonally or entire system wide activated and dispensing of the suppression foam in one or more locations where fire of extreme heat is identified through the activation of at least one corresponding remote temperature sensor 20. Each set of remote fire suppression equipment 50 is designed to protect a particular location or “zone” Zₓ within the trailer 100. In this fire suppression system 10, each set of fire suppression equipment 50 defines at least one pressurized tank 52 or pressurized foam cartridge bundle 60, connecting delivery tubing 62 or directional hose or hoses 55 or delivery tubing 62 to and leading from the tank 52 or cartridge bundles 60 to one or more dispersal spray nozzles 56 directly connecting to the singular tank through at least one remote check valve 54, the dispersal spray nozzle 56 expelling the pressurized suppression foam upon remote activation to a programmed directed location, FIGS. 4-9. In this embodiment, each remote temperature sensor 20 is attached to the trailer 100 and placed in one or more locations as determined by fire suppression experts, which and further wirelessly programmed and established communication with the fire suppression system described more specifically below, to automatically release the suppression foam to one or more dispersal spray nozzles 56 individually or collectively through activation of the corresponding remote check valves 54 upon activation, within one or more zones Zₓ over the entire trailer 100. The objective is to dispense as much quantity of suppression foam as possible to the identified area in the shortest amount of time, as time and volume are of the essence in fire suppression. It is also the objective of the fire suppression system 10 to eliminate any and all fire sources before they become irreversibly out of control. The fire suppression system 10 design and coverage should be subjectively designed and installed by expert fire suppression consultants for each trailer 10 at the manufacturing location or a qualified after-market installer.

After a fire suppression event, the fire suppression system 10 components that have been used may be replaced or recharged as needed and during the time it takes to repair the damaged components in the trailer 100. When used in the mobile trailers 100 that transport livestock or animals, greater care would be used in choosing the chemical components of the fire suppression foam to ensure that the fire suppression foam bears minimal or no harm to the livestock and animals being transported therein.

In this livestock trailer 100 embodiment, FIGS. 4-7, it is best indicated that at least partial overlapping of zones Z₁₋ₓ and WZ₁₋ₓ are recommended to ensure there are no zones insufficiently treated as over suppression is better than too little application. It is also recommended that a preference for single tank 52 use over multiple tank bundles 60 in each set of remote fire suppression equipment would be considered in the engineering and anticipated coverage aspects of the fire suppression system 10 design by experts in the fire suppression industry. Modification to the components used in this embodiment of the tanks 52, bundles 60, temperature sensors 20, remote system and trailer fire suppression system 10 and modifications thereto are contemplated within the scope of this patent application, including plumbing hardware, installation hardware, heat sensors and system activation components, foaming agents and surfactants, tank volume and pressure rechargeability and active remote status indication. It is also contemplated that a manual activation override can be incorporated into the fire suppression system 10 for alternate embodiments, not shown and certain system components may be hard-wired instead of remote wirelessly established for connection.

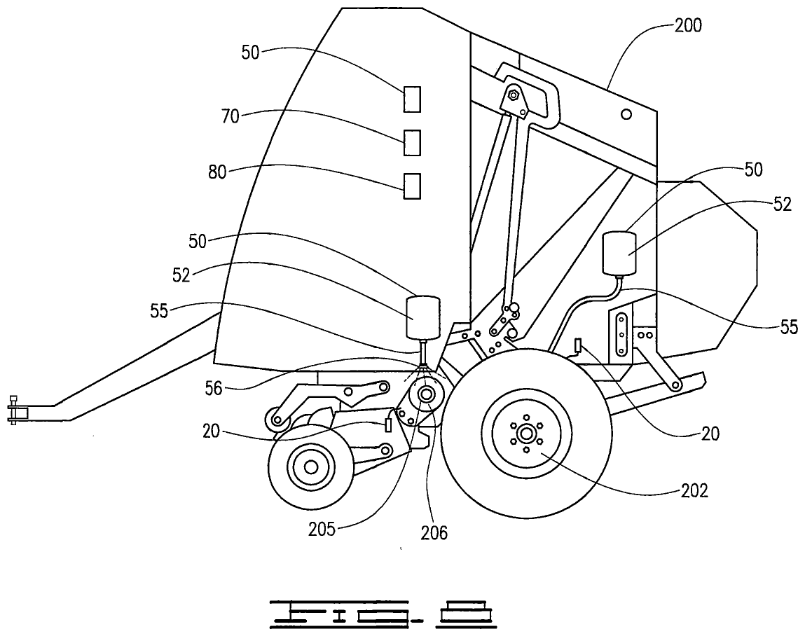

In addition to the inner portions of the trailers, it is common for fires to originate and occur underneath the trailers, especially in the vicinity of the trailer wheels 102, wheel bearings 105 and tires 104, FIG. 7. Trailers often incur flat tires during transport, which can originate a fire, especially on dual axels, where one tire remains intact while the other runs flat. This can go undetected for miles, thus making the automatic and self-activating fire suppression system 10 for trailers most unique and useful. Wheel bearing 105 failure also can result in a locked wheel, which also causes friction or sparking. Thus, the application of the remote fire suppression equipment 50 and remote temperature sensors 20 to the wheel and tire areas under the trailer is depicted in FIG. 7, representing one or more sets of remote fire suppression equipment 50 directed by delivery tubing 62 or directional hoses 55 to each wheel 102 and wheel bearing 105 on each side of the trailer 100.

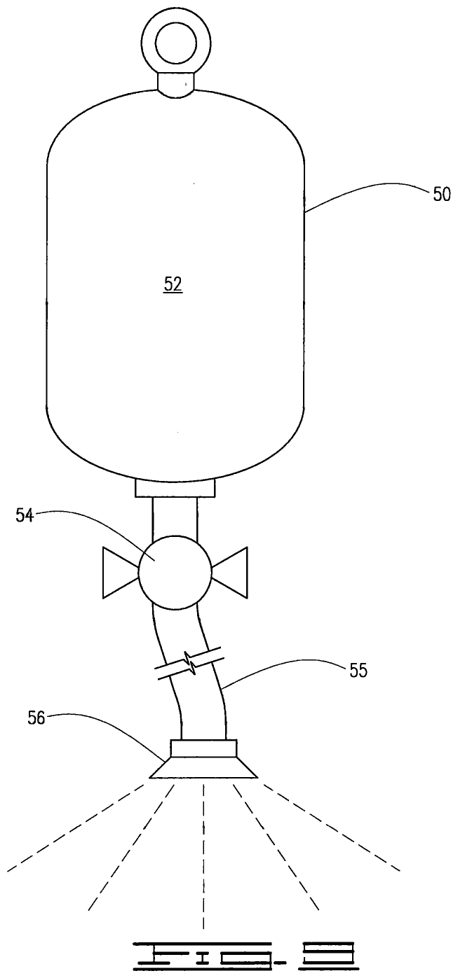

In the implement 200 version, FIG. 8, demonstrating a round bale implement, the fire suppression equipment 50 is designed and directed towards moving parts, wheels 202, pulleys 206, gears or bearings 205 operational within the equipment while in use.

Describing now more specifically the components of the present fire suppression system 10, as shown in FIGS. 1-3, the remote temperature sensor 20, FIG. 1, includes an encasement 22 housing electronic components, a base attaching means 24, which can be a magnet or an adhesive mounting surface to attach the remote temperature sensor 20 to a surface of the trailer 100, machine or implement 200 near a potential heat or ignition source, a temperature probe 25 which is pivotally directed as close to a potential heat or ignition source as possible without direct contact, an outer transmission antenna 26, also pivotal to direct the antenna towards other components of the fire suppression system modules, an internal power supply 28, and an internal probe module 30 attached to the temperature probe 25, further connected to a temperature control processor module 32 which allows for the temperature sensor 20 to be programmed to a desired temperature range by a connected sensor control module 34, the temperature control processor module further connecting a wireless signal antenna module 36 attached to the outer transmission antenna 26 sending a wireless signal to the other fire suppression system 10 components. Operation of the remote temperature sensor 20 is empowered by the internal power supply 28. These disclosed elements of this embodiment, FIG. 1, are designed to work singularly and in unison with one another throughout the trailer 100, machine or implement 200 to continuously monitor the temperature the intended target operational components.

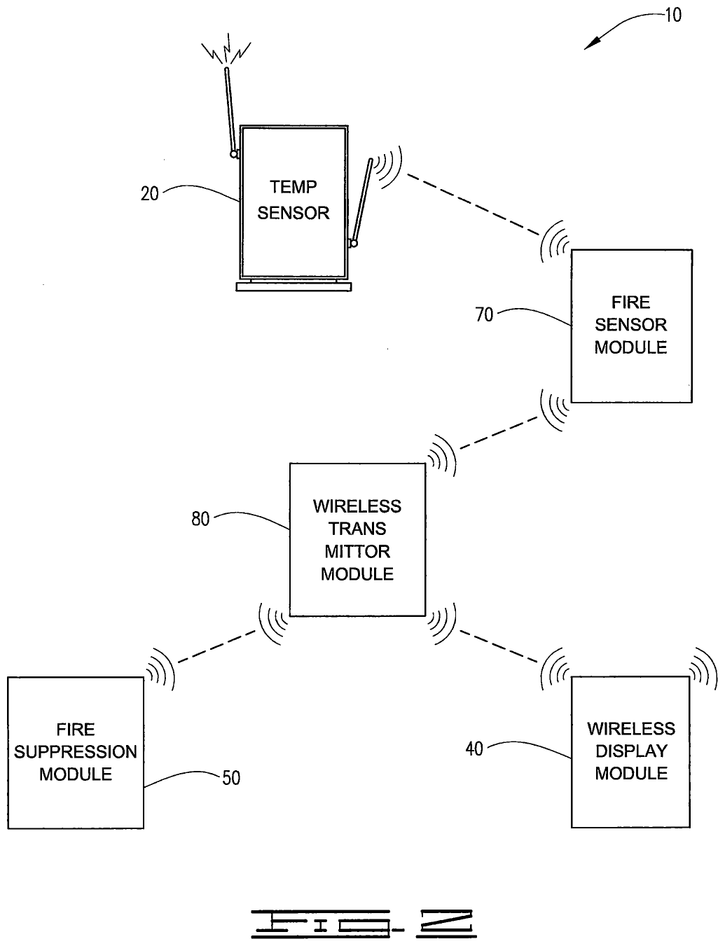

Each and every temperature sensor 20 communicates wirelessly with a fire sensor module 70 which sends a wireless signal when a fire or elevated heat signal is sent by the wireless temperature sensors 20 at a location, zone or multiple locations, which in turn communicates with a central wireless transmitter module 80, which interprets the signal for the fire suppression equipment 50 activation while monitoring up to and through a perceived fire or elevated heat event, FIG. 2, which represents one embodiment of the communication within the wireless fire suppression system 10. The central wireless transmitter module 80 is applied, most suitably externally upon the trailer 100, machine or implement 200, FIGS. 5 and 8, and relays the entire fire suppression system 10 to a wireless display module 40, which can be provided as a notebook, a tow vehicle display panel, cell phone application or another type visual and audio monitor device which provides a real time visual display of the operating system components of the fire suppression system 10, zonal display Z₁₋₆, FIG. 5, and WZ₁₋₈, FIG. 7, and other system status events. The central wireless transmitter module 80 sends a contemporaneous wireless signal to the remote fire suppression module 70 to activate one or more fire suppression remote check valves 54 corresponding to the affected location, zone or whole system, and also to the wireless display module 40 to alert the operator or monitor personnel of the activation of the one or more sets of fire suppression equipment 50 having been activated and also the location of the fire or elevated heat component on the trailer 100, machine or implement 200, allowing the operator or monitor the real time event. The wireless communication of this fire suppression system 10 occurs through BLUETOOTH® technology or WIFI connectivity and would be generally limited to a range of the fire suppression components and a tow vehicle of the trailing vehicle 100, the machine or the implement 200. It is also contemplated within the scope of this invention that the wireless communication could substitute a hard wire connection between any of the modules disclosed in FIGS. 1-9, if any connection requires such hard wire over an established wireless communication due to an engineering change requirement.

The central wireless transmitter module 80 is the hub of the wireless communication to control the entire collective wireless communication system, being the primary programmable element during origination, installation and initial activation which identifies establishes the location of the subjective fire suppression system 10. It is preprogrammed to identify the location of each remote temperature sensor 20, each set of fire suppression equipment 50 locations, control each remote check valve 54 within each set of fire suppression equipment 50, establish the real time wireless communication to the wireless display module 40, allow for manual intervention by an operator of the fire suppression system, and to record the fire or excessive heat events as they occur and preserve the record of the event. It also uses IA or logic to “decide”, using programmed prerogatives, as to whether to activate one singular fire suppression equipment 50 unit, several fire suppression equipment 50 units, or all fire suppression equipment 50 units in contemporaneously.

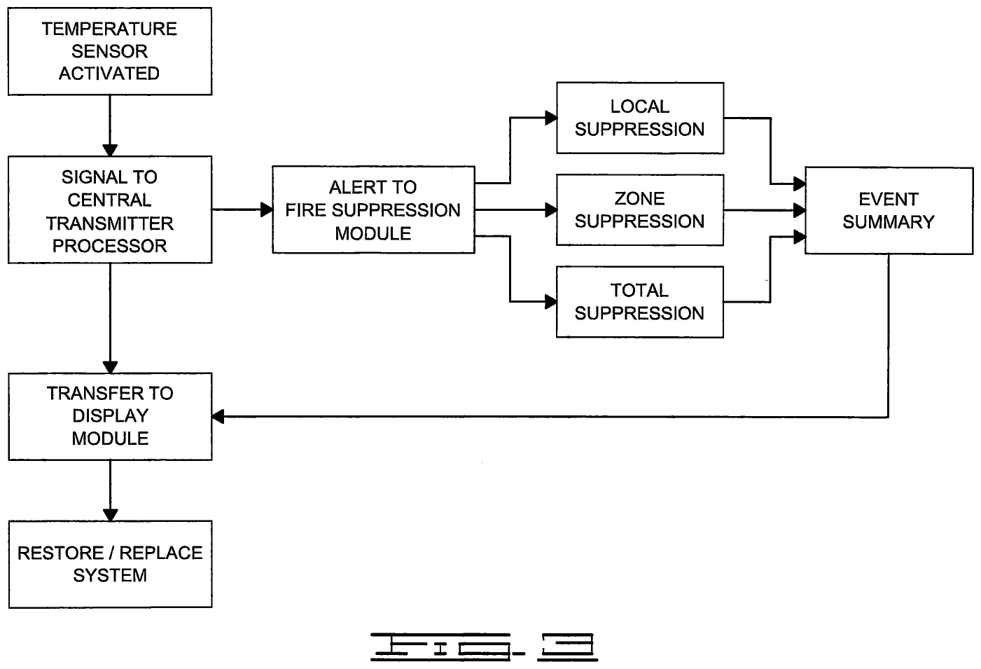

An operation flow chart of an embodiment of the fire suppression system is illustrated in FIG. 3. Upon activation or alert of one or more remote temperature sensors 20, a signal is sent to the central wireless transmitter processor 80 which relays a wireless signal to both the wireless display module 40 and the remote fire suppression module 70. The remote fire suppression module 70 processes the information gained by the wireless signal or signals and selects the most necessary option between activation of:
a) local fire suppression activation;
b) zonal fire suppression activation; or
c) total fire suppression activation.

The fire suppression system 10 and effective single tank 52 or multiple tank bundles 60, are activated by opening the respective tank or tank bundle remote check valve 54 to discharge the pressurized fire suppression foam content through the respective a dispersal spray nozzle 56 or nozzles to expel foam contents, and covey this activity information to the wireless display module 40 as they occur in real time giving the operator time to halt the trailer 100, machine or implement 200 from travel or operation at a safe location and given time and take emergency remedial action accordingly. At the conclusion of the fire event, the fire suppression system 10 returns to passive monitoring and records an event summary of the fire event and the fire suppression system is restored or replaced. After the fire event has concluded, the trailer 100, machine or implement 200 can be restored or salvaged as much as possible, saving the cargo, product, livestock or other content materials at the scene as possible, including the prevention of any loss of life or injury to living creatures or persons within those towed or operated items.

Different variations, event sequences, communication means and series are contemplated within the scope of this fire suppression system 10. Other uses not disclosed in this specification are also contemplated to include any device which may require a same or similar fire suppression system or any mechanical device that has moving parts that could result in an elevated heat event. Therefore, while the fire suppression system 10 and wireless communication network, controls and wireless real time monitoring systems have been particularly shown and described with reference to a preferred embodiment thereof, it will be understood by those skilled in the art that changes in form and detail may be made therein without departing from the spirit and scope of the invention.

What is claimed is:

1. A fire suppression system using a wireless communication system, said fire suppression system comprising:
a central wireless transmitter module;
a wireless display module;
one or more sets of remote fire suppression equipment including at least one tank containing a pressurized fire suppression foam content, one or more dispersal spray nozzles directed to a location, zones or said one or more sets of remote fire suppression equipment locations installed within a mobile trailer, machine or implement;
at least one temperature sensor installed at one or more locations upon said trailer, machine or implement at a potentially potential heat or fire source locations, wherein said at least one temperature sensor detects a fire or elevated heat event sends a wireless communication signal to said central wireless transmitter module, which further sends a wireless communication signal to said at least one set of remote fire suppression equipment through a remote fire suppression module to disperse said pressurized fire suppression foam content to said fire or elevated heat event locations while contemporaneously and in real time sends a wireless communication signal to said wireless display module to alert an operator of said trailer, machinery or implement as to a real time fire event and real time status of the fire suppression system in order to mitigate damage to said trailer, machinery or implement.

2. The fire suppression system using a wireless communication system fire suppression system using a wireless communication system of claim 1, said fire suppression system further comprising:
said one or more sets of fire suppression equipment are installed in one or more individual locations, areas or zones of said trailer, machine or implement interior and exterior; where fire or extreme heat events may occur and where at least one corresponding remote temperature sensor is correspondingly installed, each set of said fire suppression equipment defining at least one pressurized tank or pressurized foam cartridge bundle, connecting delivery tubing or directional hose to and leading from said tank or cartridge bundles to one or more dispersal spray nozzles directly connecting to said pressurized tank or tank bundle through at least one remote check valve, wherein said dispersal spray nozzle, upon remote activation of said at least one remote check valve, expels said pressurized suppression foam content to said location, zones or said one or more sets of remote fire suppression equipment locations installed within a mobile trailer, machine or implement.

3. The fire suppression system using a wireless communication system fire suppression system using a wireless communication system of claim 1, said remote temperature sensor further comprising:
an encasement comprising a base attaching means attaching to said mobile trailer, machine or equipment containing an internal power supply;
a temperature probe pivotally attaching to said encasement and directed to said potential fire or elevated heat event location;
a transmission antenna pivotally attaching to said encasement;
an internal probe module attached to said temperature probe and a wireless signal antenna module attached to said transmission antenna, said internal probe module and said wireless signal antenna module attaching respectively to a sensor control module which is programmable as to a selected temperature range, wherein said remote temperature sensor wirelessly communicates within said fire suppression system once said selected temperature range is exceeded to activate said one or more sets of remote fire suppression equipment and signal said wireless display module in real time.

4. The fire suppression system using a wireless communication system fire suppression system using a wireless communication system of claim 1, wherein a respective said remote temperature sensor and each corresponding set of remote fire suppression equipment is installed and directed to a wheel, tire, bearing and/or pulley located on said mobile trailer, machine or implement and integrated by independent wireless communication to said wireless display module, remote fire suppression module and said central wireless transmitter module and independently programmed through said central wireless transmitter module upon initial installation to establish said wireless communication system.

5. The fire suppression system using a wireless communication system fire suppression system using a wireless communication system of claim 1, wherein said base attaching means of said remote temperature sensor is magnetic or establish by an adhesive attaching said remote temperature sensor to said interior or exterior of said mobile trailer, machine or implement at each respective location as chosen, enabling said remote temperature sensor to be selectively and subjectively installed upon or within said mobile trailer, machine or implement.

6. The fire suppression system using a wireless communication system fire suppression system using a wireless communication system of claim 1, further comprising any other element or component as disclosed within the specification or drawing figures.
